(19) United States
(12) Patent Application Publication
(10) Pub. No.: US 2019/0253626 A1
(43) Pub. Date: Aug. 15, 2019

(54) TARGET TRACKING METHOD AND AIRCRAFT

(71) Applicant: AUTEL ROBOTICS CO., LTD., Shenzhen (CN)

(72) Inventor: Zuoguang LI, Shenzhen (CN)

(21) Appl. No.: 16/393,077

(22) Filed: Apr. 24, 2019

Related U.S. Application Data
(63) Continuation of application No. PCT/CN2017/106141, filed on Oct. 13, 2017.

(30) Foreign Application Priority Data
Oct. 27, 2016 (CN) 201610969823.4

(51) Int. Cl. H04N 5/232; H04N 5/247; B64D 47/08; B64C 39/02; G05D 1/12

(52) U.S. Cl. CPC H04N 5/23238; H04N 5/247; H04N 5/23299; B64C 2201/127; B64D 47/08; B64C 39/024; G05D 1/12; H04N 5/23218

(57) ABSTRACT

This disclosure discloses a target tracking method and an aircraft. The method includes: obtaining an image captured by each of at least two cameras at a same time point, where photography directions of the at least two cameras are different; stitching the images to obtain a panoramic image; and if a target object is identified in the panoramic image, tracking the target object. Efficiency of identifying the target object may be improved by using the panoramic image, and effective tracking may be performed on the identified target object.

### CROSS REFERENCE

The present application is a continuation of International Application NO. PCT/CN2017/106141, filed on Oct. 13, 2017, which claims priority to Chinese Patent Application No. 201610969823.4, filed with the Chinese Patent Office on Oct. 27, 2016, and entitled “UNMANNED AERIAL VEHICLE PANORAMIC VISION TRACKING METHOD, UNMANNED AERIAL VEHICLE AND CONTROL TERMINAL”, both of which are incorporated herein by reference in their entireties.

### TECHNICAL FIELD

The present invention relates to the field of unmanned aerial vehicles (UAV), and in particular, to a target tracking method, an aircraft and a control terminal.

### RELATED ART

Currently, image transmission technologies can support an aircraft in transmitting an image sequence captured by the aircraft to a control terminal in real time. With the development of image processing technologies, the aircraft can identify a target and track the identified target.

In an existing target tracking manner, the aircraft performs vision tracking on a target object by using an image captured by the aircraft. However, a camera provided on the aircraft has a restricted photography view. For example, generally, a photography field of view (FOV) of the camera is around 100 degrees. That is, the camera provided on the aircraft can capture only images in a range of the FOV of the camera and cannot capture images out of the FOV. In this way, there may be a case in which the target object is out of the FOV of the camera. In this case, the aircraft cannot obtain, by using the camera, an image including the target object and further cannot perform target tracking on the image.

Therefore, existing target tracking technologies still need to be improved and developed.

### SUMMARY

Embodiments of the present invention provide a target tracking method, an aircraft and a control terminal. Efficiency of identifying the target object may be improved by using the panoramic image, and effective tracking may be performed on the identified target object.

According to a first aspect, an embodiment of the present invention provides a target tracking method. The method is applied to an aircraft and includes:

obtaining an image captured by each of at least two cameras at the same time, where photography directions of the at least two cameras are different;

stitching the images captured by the cameras to obtain a panoramic image; and

if a target object is identified in the panoramic image, tracking the target object.

According to a second aspect, an embodiment of the present invention provides an aircraft, including:

a central housing;

an aim;

at least two cameras, where the at least two cameras are located on the central housing or the arm and photography directions of the at least two cameras are different;

a tracking processor, disposed in the central housing or the arm;

a power apparatus, disposed on the arm; and

a vision processor, disposed in the central housing or the aim, where

the vision processor is configured to: obtain images captured by each of the at least two cameras at the same time, and stitch the images captured by the cameras to obtain a panoramic image;

the vision processor is further configured to identify a target object in the panoramic image and to send an instruction for tracking the target object to the tracking processor; and

the tracking processor controls, based on the instruction, a rotation speed of the power apparatus to track the target object.

According to a third aspect, an embodiment of the present invention provides an aircraft, including a functional unit. The functional unit is configured to perform the method according to the first aspect.

According to a fourth aspect, an embodiment of the present invention provides a computer-readable storage medium. The computer-readable storage medium stores program code and the program code is configured to perform the method according to the first aspect.

In the embodiments of the present invention, images captured by each of at least two cameras at the same time are obtained, where photography directions of the at least two cameras are different. The images are stitched to obtain a panoramic image. If a target object is identified in the panoramic image, tracking is performed on the target object. Efficiency of identifying the target object may be improved by using the panoramic image, and effective tracking may be performed on the identified target object.

### BRIEF DESCRIPTION OF THE DRAWINGS

FIG. 1 is a schematic structural diagram of a UAV according to an embodiment of the present invention;

FIG. 2 is a schematic flowchart of a target tracking method according to an embodiment of the present invention;

FIG. 3 is a schematic diagram of an FOV corresponding to a panoramic image according to an embodiment of the present invention;

FIG. 4 is a schematic flowchart of another target tracking method according to an embodiment of the present invention;

FIG. 5 is a schematic diagram of a type of interaction between an aircraft and a control terminal according to an embodiment of the present invention;

FIG. 6 is a schematic flowchart of still another target tracking method according to an embodiment of the present invention;

FIG. 7 is a schematic diagram of another type of interaction between an aircraft and a control terminal according to an embodiment of the present invention;

FIG. 8 is a schematic flowchart of still another target tracking method according to an embodiment of the present invention;

FIG. 9 is a schematic diagram of still another type of interaction between an aircraft and a control terminal according to an embodiment of the present invention;

FIG. 10 is a schematic flowchart of an abnormal case processing method according to an embodiment of the present invention;

FIG. 11 is a schematic structural diagram of an aircraft according to an embodiment of the present invention;

FIG. 12 is a schematic structural diagram of units of an aircraft according to an embodiment of the present invention;

FIG. 13 is a schematic structural diagram of a control terminal according to an embodiment of the present invention; and

FIG. 14 is a schematic structural diagram of units of a control terminal according to an embodiment of the present invention.

### DETAILED DESCRIPTION

Embodiments of the present invention provide a target tracking method and a related device.

The following first describes an execution apparatus involved in the embodiments of the present invention. The execution apparatus may be configured to perform the method provided by the embodiments of the present invention. For example, the execution apparatus may include a UAV.

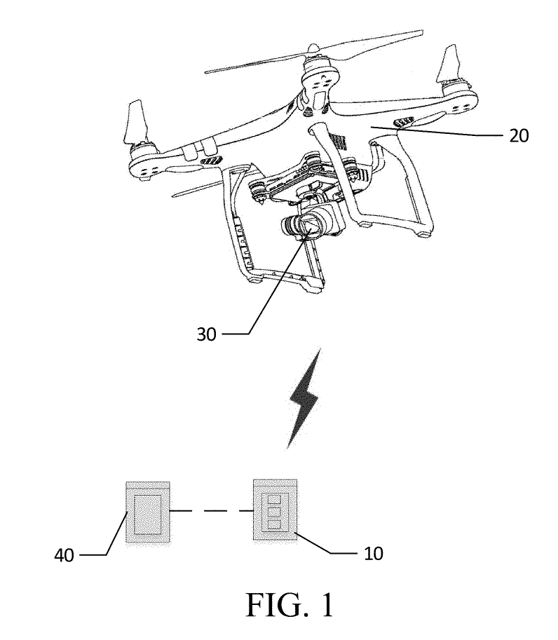

Referring to FIG. 1, FIG. 1 is a schematic diagram of an architecture of a UAV according to an embodiment of the present invention. The UAV can be used to implement the target tracking method.

For example, the UAV shown in FIG. 1 may include an aircraft 20 and a control terminal 10 configured to control the aircraft. The aircraft 20 may be in wireless connection to the control terminal 10. For example, wireless connection may be implemented by using a wireless fidelity (Wi-Fi) technology, a Bluetooth technology or a mobile communications technology such as a 3rd Generation (3G), 4th Generation (4G) or 5th Generation (5G) mobile communications technology. This is not limited herein. After the aircraft 20 is in wireless connection to the control terminal 10, the aircraft 20 may transmit image data and the like to the control terminal 10 and the control terminal 10 may transmit a control instruction and the like to the aircraft 20. Alternatively, the aircraft 20 and the control terminal 10 may unilaterally transmit the image data by using another wireless communications technology. To be specific, the aircraft 20 transmits the image data to the control terminal by using the wireless communications technology in real time. Herein, the wireless communications technology used between aircraft 20 and the control terminal 10 is not specifically limited in this embodiment of the present invention.

The aircraft 20 may be connected to a camera by using a configured gimbal interface. In this embodiment of the present invention, the aircraft 20 may be connected to at least two cameras by using the configured gimbal interface. A photography direction of each of the connected cameras is different.

A camera 30 described in this embodiment of the present invention may be connected to the gimbal interface of the aircraft 20 by using a gimbal, or may be directly connected to the gimbal interface of the aircraft. This is not limited herein. When the camera 30 is directly connected to the gimbal interface of the aircraft, the camera 30 may alternatively be understood as a gimbal camera. The photography direction of each camera may be physically fixed or may be controlled by the aircraft. This is not limited herein.

The quantity of cameras connected to the aircraft 20 may be related to an FOV of each camera. Herein, the FOV of a camera corresponds to a photography view of the camera. That is, a larger FOV of the camera indicates a wider photography view of the camera. The FOV may be understood as an attribute of the camera and is determined by physical construction of the camera. For example, if the FOV of each camera is 120 degrees, three cameras may be configured to be connected to the aircraft. If the FOV of each camera is 180 degrees, two cameras may be configured to be connected to the aircraft. Alternatively, another configuration quantity of cameras may be determined, so that images captured by the cameras in photography directions corresponding to the cameras can be stitched to a panoramic image. This is not limited herein.

It should be noted that, the aircraft 20 shown in FIG. 1 is merely an example. The aircraft 20 may be a four-rotor aircraft, an aircraft provided with another quantity of rotors or an aircraft provided with another type of wings. This is not limited herein. The camera 30 connected to the aircraft 20 is also merely an example. The example is used to describe a connection position relationship between the aircraft 20 and the connected camera 30. Certainly, the connection position relationship between the aircraft 20 and the connected camera 30 may further include another relationship manner, which is not limited herein.

The control terminal 10 in this embodiment of the present invention is a device configured to perform wireless communication with the aircraft. The control terminal 10 may send a control instruction to the aircraft 20 to control a flight status of the aircraft, or may receive a signal or image data from the aircraft 20. The control terminal 10 may be provided with a display screen, configured to display an image based on the image data. Alternatively, the control terminal 10 may be connected to a user terminal 40 to transmit the received image data or other information to the user terminal for displaying. The control terminal 10 may be in wireless or wired connection to the user terminal 40. This is not limited herein. The user terminal 40 may include, but not limited to, a smartphone, a tablet computer, a wearable device such as a smart watch, a smart band or a head mounted display (HMD) device. The HMD may display an image by using an aggregate reality (AR) technology or a virtual reality (VR) technology. This is not limited herein.

The following describes the method performed by the aircraft and the control terminal in the UAV and structures of the aircraft and the control terminal.

The following describes, based on the architecture of the UAV, some method embodiments provided by the embodiments of the present invention.

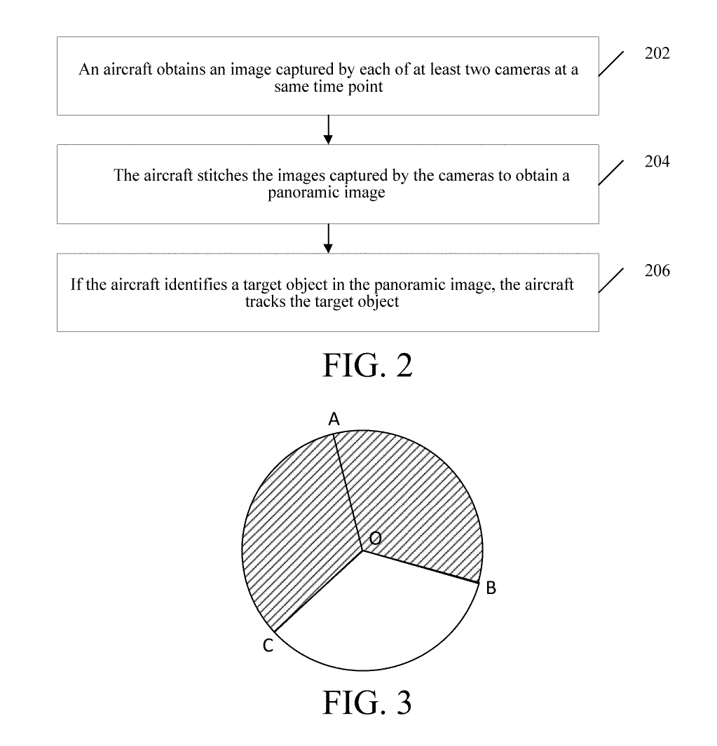

Referring to FIG. 2, FIG. 2 is a schematic flowchart of a target tracking method according to an embodiment of the present invention. As shown in FIG. 2, the method includes at least the following steps.

Step 202: An aircraft obtains an image captured by each of at least two cameras at a same time point, where photography directions of the at least two cameras are different.

For example, the aircraft may control the at least two cameras connected to the aircraft to capture a video or an image. Videos captured by multiple cameras may be understood as an image sequence based on a timeline. The aircraft may obtain, based on a time point, an image corresponding to the time point from the image sequence captured by each camera, so as to obtain multiple images captured by the multiple cameras at a same time point.

For example, the cameras may perform photographing at a same time point based on a synchronization signal sent by the aircraft. Herein, images captured by the cameras at the same time point are images captured by the cameras in a time range including a time point. The time range may be determined by using a synchronization error and is not limited herein.

For example, the aircraft may obtain images captured by the cameras at a same point periodically or in real time. This is not limited herein.

For example, if the quantity of the at least two cameras is N, the aircraft may control M of the N cameras to start photographing at a same time point. N and M are positive integers and M≤N. Further, the aircraft may obtain M images captured by the M cameras at the same time point.

A photography direction and an FOV of a camera are related to a photography range of the camera. Further, photography directions of the cameras are different, so that photography ranges of the cameras are different and images captured by the cameras in the photography ranges of the cameras are also different. A photography direction of at least one of the multiple cameras may be fixed or changeable. For example, the aircraft controls an attitude of the at least one camera to change, thereby further controlling the photography direction of the at least one camera to change.

Optionally, before controlling the multiple cameras to simultaneously perform photographing, the aircraft may further control photography stability of the cameras. The photography stability of the cameras is improved by using a gimbal connected by controlling the aircraft, so that images of higher quality can be obtained.

Step 204: The aircraft stitches the images captured by the cameras to obtain a panoramic image.

For example, the aircraft may stitch multiple images by using an image stitching technology to obtain an image with a larger angle of view. In this embodiment of the present invention, the aircraft may obtain, by using the image stitching technology, the panoramic image that is based on three-dimensional coordinates.

For example, it is assumed that photography ranges of two cameras overlap. When stitching is performed on two images captured by the two cameras, first, feature comparison may be performed on images in edge areas of the two images to determine whether a part of the two images overlap. If the feature comparison succeeds, it may be determined that a part of the two images overlap, so that the overlapped part of the images needs to be processed. For example, after stitching is performed, a pixel grayscale of the overlapped part of the images is set to an average value. Alternatively, before stitching is performed, a pixel grayscale of an overlapped part included by each of the two images is set to the average value, and then stitching is performed. This is not limited herein.

For example, the multiple images obtained by the aircraft may be two-dimensional images or three-dimensional images. This is not limited herein. The aircraft may obtain a two-dimensional panoramic image by using multiple two-dimensional images or may obtain a three-dimensional panoramic image by using multiple three-dimensional images. Further, after obtaining the two-dimensional panoramic image, the aircraft may perform space conversion on the two-dimensional panoramic image to convert the two-dimensional panoramic image into a three-dimensional panoramic image. The three-dimensional panoramic image means that coordinates of a pixel in an image are three-dimensional coordinates. The three-dimensional panoramic image may alternatively be understood as a spherical panoramic image.

For example, if the aircraft obtains M images captured by M of N cameras at a same time point, the M images may be stitched to obtain a panoramic image. The panoramic image described herein means that the panoramic image corresponds to a wider FOV compared with the M images. The panoramic image is not limited to corresponding to an omnidirectional FOV in a space.

The following describes an example of a relationship between an FOV corresponding to each image and an FOV corresponding to a panoramic image with reference to FIG. 3.

As shown in FIG. 3, an aircraft is connected to three cameras. An FOV of each of the three cameras is 120 degrees. The three cameras may be located at a position of an origin O. An angle AOB is used to represent an FOV of a first camera in a dimension. An angle AOC is used to represent an FOV of a second camera in the dimension. An angle BOC is used to represent an FOV of a third camera in the dimension. The aircraft may control the three cameras to photograph at a same time point, so that the aircraft may obtain three images at the time point. The FOV corresponding to each of the three images is 120 degrees. Further, the aircraft may stitch the three images to obtain a panoramic image. In this case, an FOV corresponding to the panoramic image in the dimension is 360 degrees, that is, an omnidirectional FOV. Alternatively, the aircraft may control two of the three cameras to photograph at a same time point or the aircraft controls the three cameras to photograph at a same time point to obtain images captured by two of the three cameras. This is not limited herein. The aircraft may stitch two images captured by two cameras. As shown in FIG. 3, the aircraft obtains a first image captured by the first camera and a second image captured by the second camera. An FOV corresponding to the first image is the angle AOB and an FOV corresponding to the second image is the angle AOC. After stitching the first image and the second image, the aircraft may obtain a panoramic image. In this case, an FOV corresponding to the panoramic image in the dimension is 240 degrees. That is, the FOV corresponding to the panoramic image obtained by the aircraft is larger than an FOV of an image captured by a camera. This increases possibility of photographing a target object.

Certainly, the aircraft may further obtain M images captured by M of N cameras and stitch the M images to obtain a panoramic image corresponding to the omnidirectional FOV. This is not limited herein.

That is, the aircraft may obtain multiple images by using different FOVs of the N cameras and stitch the multiple images to obtain multiple panoramic images corresponding to different FOVs. A display range of each of these panoramic images is larger than a display range of an image captured by each of the N cameras.

Step 206: If the aircraft identifies a target object in the panoramic image, the aircraft tracks the target object.

For example, after obtaining the panoramic image, the aircraft may trigger target object identification on the panoramic image based on a control instruction sent by a control terminal, or the aircraft may trigger target object identification on the panoramic image based on a current mode, or the aircraft may trigger target object identification on the panoramic image based on another triggering condition. This is not limited herein.

For example, the aircraft may determine a to-be-identified target object based on indication information of the control terminal, or the aircraft may determine a to-be-identified target object based on an established background model. For a specific implementation, refer to the following embodiments.

For example, after performing target object identification on the panoramic image, the aircraft may generate an identification result which indicates that the identification succeeds or the identification fails. If the identification succeeds, that is, the aircraft identifies the target object in the panoramic image and the aircraft can track the target object. If the identification fails, the aircraft does not track the target object. Optionally, the aircraft may further send a result indicating that the identification fails to the control terminal by using a notification message. An identification manner of the target object is not specifically limited in this embodiment of the present invention.

For example, an implementation of tracking the target object may be as follows: Multiple pieces of position information of the target object are respectively obtained from the multiple panoramic images obtained by the aircraft. The position information of the target object includes a position at which the target object is located in the panoramic image, an image range of the target object and the like. Movement track information of the target object may be determined based on the multiple pieces of position information of the target object. The movement track information may include relative distance information and direction information of the target object and the aircraft. Further, the target object may be tracked based on the determined movement track information. For example, the aircraft may position the target object and determine positioning information of the aircraft based on positioning information, the relative distance information and the direction information of the target object. Further, the aircraft can fly to a position represented by the positioning information.

Certainly, the aircraft may further track the target object in another manner, which is not limited herein.

Optionally, before tracking the target object, the aircraft may further send a request message to the control terminal to request to track the target object. If receiving a response for the request message of the control terminal, the aircraft tracks the target object; otherwise, the aircraft does not track the target object. Alternatively, if confirming that the current mode is a tracking mode, the aircraft tracks the target object. Alternatively, if confirming that the current mode is not a tracking mode, the aircraft sends a mode switching request to the control terminal and determines, based on a response for the mode switching request sent by the control terminal, whether to switch the current mode to the tracking mode and track the target object.

Optionally, the aircraft may include multiple tracking modes, for example, an ordinary tracking mode, a parallel tracking mode and an encircling tracking mode. This is not limited herein. The ordinary tracking mode means that the aircraft maintains a relative distance from the target object or calculates a shortest distance from the target object in real time and tracks the target object by using the relative distance or the shortest distance. The parallel tracking mode means that the aircraft maintains a relative angle or a relative distance with the target object and tracks the target object by using the relative angle or the relative distance. The encircling tracking mode means that the aircraft maintains a relative distance from the target object and flies by using the target object as a center of a circle and surrounding the target object in a circular track or a quasi-circular track.

Optionally, the aircraft may further send the panoramic image to the control terminal and the control terminal receives the panoramic image.

For example, the control terminal may receive the panoramic image by using a general wireless communications technology or an image transmission system configured by the control terminal. This is not limited herein.

Optionally, the control terminal may control a display screen to display the panoramic image.

For example, the display screen described in this embodiment of the present invention may be a display screen provided in the control terminal or may be a display screen provided on a user terminal connected to the control terminal.

For example, if the panoramic image is a three-dimensional panoramic image, the control terminal may convert the three-dimensional panoramic image into a two-dimensional panoramic image and control a display to display all two-dimensional images. Alternatively, the control terminal may control the display screen to display a part of the three-dimensional panoramic image. If the display screen displays a part of the panoramic image, the part of the image displayed by the display screen may be related to a movement parameter of the display screen or an operation body. For example, when the control terminal is provided with the display screen or when the control terminal is connected to the user terminal provided with the display screen, and the display screen moves as an entirety, the movement parameter of the display screen may be obtained by using a sensor provided in the control terminal or the user terminal, for example, a rotation direction of the display screen. In this way, a part of the image corresponding to the movement parameter may be determined to control the display screen to perform displaying. For another example, when the control terminal is connected to an HMD, the HMD may obtain a head portion movement parameter, an eyeball movement parameter or the like of a wearer to determine a part of the image corresponding to the movement parameter and display the part of the image on the display screen. Certainly, a part of the image corresponding to another parameter may be determined based on the another parameter such as a gesture operation parameter. This is not limited herein.

Optionally, the control terminal may receive a user operation or receive a user operation by using the connected user terminal, for example, a touch operation or a voice operation. The control terminal may determine the target object based on the user operation.

Alternatively, optionally, the control terminal may receive area information for the target object sent by the aircraft, determine the target object based on the area information, and control the display screen to highlight the target object. For a specific implementation, refer to the following embodiments.

It should be noted that, in the foregoing embodiment, only two cameras are used as examples. It should be understood that, the method described in this embodiment of the present invention can also be applied to at least images. For example, for an obtaining method and a stitching method of at least two images, refer to the obtaining method and the stitching method of two images, which is not described herein again.

In this embodiment of the present invention, the image captured by each of the at least two cameras at the same time point is obtained, where the photography directions of the at least two cameras are different. The images are stitched to obtain the panoramic image. If the target object is identified in the panoramic image, tracking is performed on the target object. Efficiency of identifying the target object may be improved by using the panoramic image, and effective tracking may be performed on the identified target object.

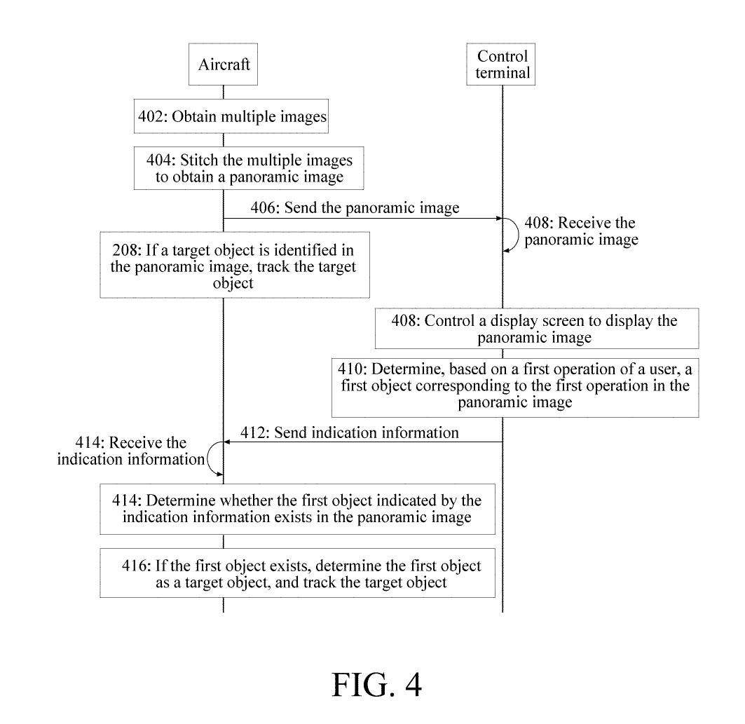

Referring to FIG. 4, FIG. 4 is a schematic flowchart of another target tracking method according to an embodiment of the present invention. As shown in FIG. 4, the method includes at least the following steps.

Step 402: An aircraft obtains an image captured by each of at least two cameras at a same time point, where photography directions of the multiple cameras are different.

Step 404: The aircraft stitches the images captured by the cameras to obtain a panoramic image.

Step 406: The aircraft sends the panoramic image to a control terminal.

Step 408: The control terminal receives the panoramic image and controls to display the panoramic image.

For specific descriptions of step 402 to step 408, refer to related descriptions in the foregoing embodiments, which is not described herein again.

Step 410: The control terminal determines, based on a first operation of a user, a first object corresponding to the first operation in the panoramic image.

For example, after controlling a display screen to display a part of or the entire panoramic image, the control terminal receives a user operation. For example, a local end of the control terminal receives the user operation or the control terminal receives the user operation by using a connected user terminal. The first operation of the user is used for determining the first object in displayed objects as a target object. Further, the control terminal may determine the first object in the panoramic image as the target object by using the first operation of the user.

Step 412: The control terminal sends indication information to the aircraft, the indication information being used for indicating the first object.

For example, the indication information may include feature information of the first object or position information of the first object in the panoramic image.

Step 414: The aircraft receives the indication information and determines whether the first object indicated by the indication information exists in the panoramic image.

For example, after receiving the indication information, the aircraft may determine the first object in the panoramic image based on the feature information, the position information or the like in the indication information. If an object corresponding to the feature information in the indication information exists in the panoramic image, it may be determined that the first object is identified in the panoramic image; or if an object corresponding to the position information exists in the panoramic image, it may be determined that the first object is identified in the panoramic image. Certainly, the first object may alternatively be identified with reference to the foregoing information or other information in indication information. This is not limited herein.

Further, the first object may be identified in a set of panoramic image sequences. The set of panoramic image sequences may include or may not include the panoramic image on which the first operation of the user is based. This is not limited herein. A photography range corresponding to each panoramic image in the set of panoramic image sequences may be the same as or may overlap a photography range corresponding to the panoramic image on which the first operation of the user is based. This is not limited herein. The quantity of images in which the first object can be identified is counted in the set of panoramic image sequences. A proportion of the quantity of the images in a total quantity of images of the set of panoramic image sequences is calculated. If the proportion is greater than or equal to a preset threshold, it indicates that identification reliability (or identification confidence) of the aircraft for the first object is high. That is, the aircraft determines that identification on the first object succeeds and tracking can be performed on the first object. If the proportion is less than the preset threshold, it indicates that identification reliability (or identification confidence) of the aircraft for the first object is low. That is, the aircraft determines that identification on the first object fails and can notify the control terminal of an identification result by using a notification message. After receiving the notification message, the control terminal may prompt or control the user terminal to prompt the user to re-determine a target object.

Step 416: If the first object exists, determine the first object as a target object, and track the target object.

Optionally, if the first object is identified in the panoramic image, the aircraft may further send a request message to the control terminal, the request message being used for requesting the control terminal to confirm in to track the target object. After a confirmation response of the control terminal for the request message is received, tracking is then performed on the target object.

Optionally, when tracking the target object, the aircraft may capture an image or video by using a connected camera. Further, the aircraft may transmit the captured image or video to the control terminal in real time and the control terminal controls to display the captured image or video. Further, the aircraft may identify the target object in the captured image or video and send area information of the identified target object to the control terminal. The control terminal determines a position of the target object in the panoramic image based on the area information and highlights an image corresponding to the position, so that the user can observe the target object in time and determine whether the target object tracked by the aircraft is correct, thereby improving accuracy of tracking the target object by the aircraft.

In this embodiment of the present invention, interaction with the user may be implemented. Tracking is performed on a target object required by the user and user experience is enhanced.

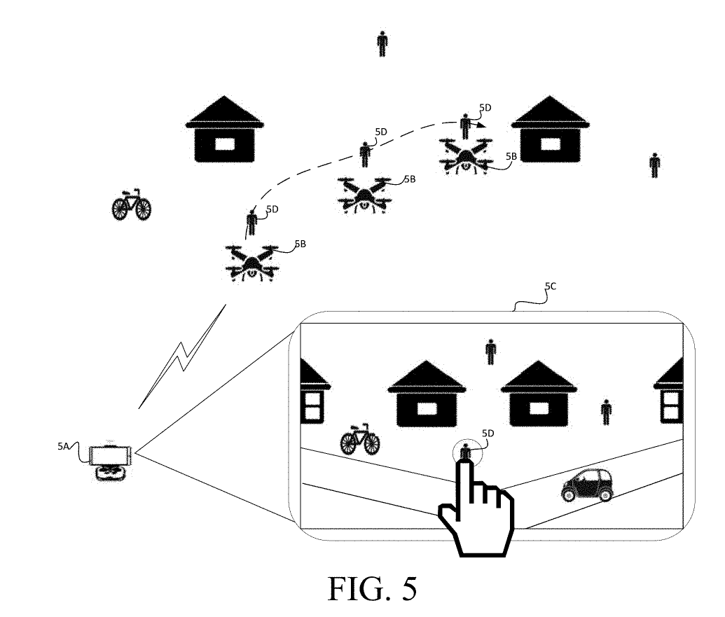

The foregoing embodiment is described below with reference to FIG. 5. As shown in FIG. 5, an aircraft 5B may obtain a panoramic image by stitching images captured by multiple cameras connected to the aircraft 5B and may transmit the panoramic image to a control terminal 5A. The control terminal 5A may control a display screen 5C to display a part of or the entire panoramic image. This is not limited herein. An image displayed by the display screen 5C is shown in FIG. 5. In FIG. 5, after the display screen displays the panoramic image, the user may select a to-be-tracked target object. For example, the user determines a to-be-tracked target object 5D by using a touch operation. Optionally, after the to-be-tracked target object 5D is determined, the target object can be highlighted in the panoramic image. A specific manner of prominent displaying is not limited herein. For example, the control terminal 5A may send, to the aircraft 5B, indication information used for indicating the target object. The indication information may include position information of the target object in the panoramic image and a feature of the target object. In this way, the aircraft 5B may identify the target object based on the received indication information. For example, the aircraft 5B may first determine a to-be-identified image area based on the position information, to determine whether a feature included in the indication information exists in the image area, and if yes, it indicates that the aircraft 5B identifies the target object 5D. Optionally, the aircraft 5B may further determine, based on a panoramic image list obtained by the aircraft 5B, whether identification on the target object 5D succeeds. If the identification succeeds, the aircraft 5B may track the target object 5D. Further, if the identification fails, the aircraft 5B may send a notification message to the control terminal 5A to notify that the identification fails. After receiving the notification message, the control terminal 5A may prompt the user to re-determine a target object.

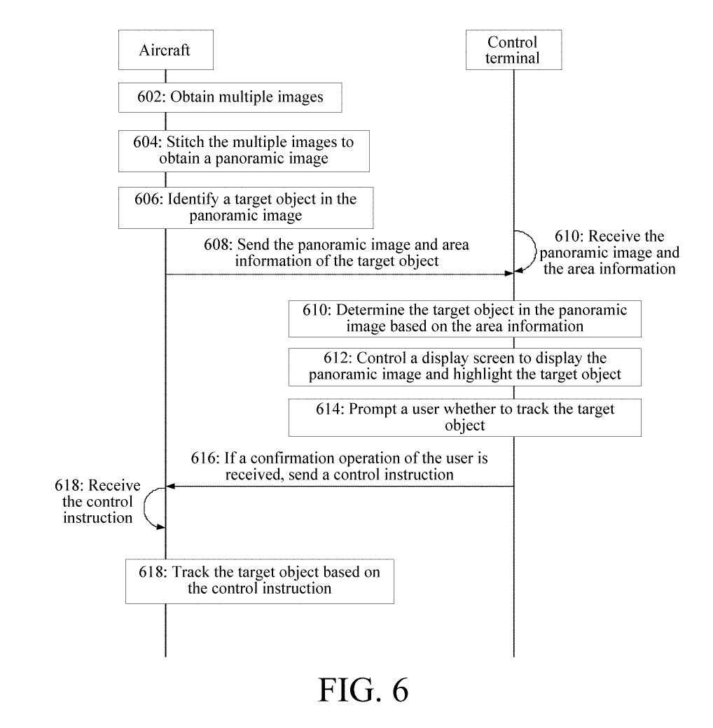

Referring to FIG. 6, FIG. 6 is a schematic flowchart of still another target tracking method according to an embodiment of the present invention. As shown in FIG. 6, the method includes at least the following steps.

Step 602: An aircraft obtains an image captured by each of at least two cameras at a same time point, where photography directions of the multiple cameras are different.

Step 604: The aircraft stitches the images captured by the cameras to obtain a panoramic image.

For specific descriptions of step 602 to step 604, refer to related descriptions in the foregoing embodiments, which is not described herein again.

Step 606: The aircraft identifies a target object in the panoramic image.

For example, the aircraft may identify the target object by using a target identification algorithm. The target identification algorithm is not limited in the present invention. For example, the aircraft may match a pre-stored feature with the panoramic image. If an object matching the feature exists, the object can be determined as the target object.

Alternatively, the aircraft may compare the panoramic image with a pre-stored background model. Herein, the background model may be established by training a model based on multiple panoramic images collected by the aircraft at a same position. For example, common features of the multiple panoramic images are determined and the features are mapped to the background model. Certainly, the background model may be obtained in another manner, which is not limited herein.

After the aircraft compares the panoramic image with the pre-stored background model, if a feature that does not exist in the background model exists in the panoramic image, the aircraft determines that the feature that does not exist is a target feature.

Step 608: The aircraft sends the panoramic image and area information of the target object to a control terminal.

Step 610: The control terminal receives the panoramic image and the area information and determines the target object in the panoramic image based on the area information.

For example, the area information of the target object may refer to pixel coordinates included in an image corresponding to the target object. The control terminal may determine the target object based on the pixel coordinates.

Step 612: The control terminal controls a display screen to display the panoramic image and highlights the target object.

For example, the control terminal may control a display to display a part of or the entire panoramic image and highlight the target object. For example, the control terminal may control the display to display a part of the image in a first display area. The part of the image includes the target object and is displayed to the target object. The control terminal may control the display to display the panoramic image in a second display area and may further mark, in the panoramic image, a position at which the part of the image displayed in the first display area is located in the panoramic image. Herein, a display manner of the display is not limited in this embodiment of the present invention. The display screen highlights the target object for a purpose of prompting the user whether to track the target object identified by the aircraft.

Step 614: The control terminal prompts a user whether to track the target object.

For example, the control terminal may prompt the user whether to track the target object by outputting a prompt box, in a manner of voice prompt or the like.

Step 616: If receiving a confirmation operation of the user, the control terminal sends a control instruction to the aircraft.

For example, the confirmation operation of the user may be a touch operation, a voice operation, an air gesture operation, another operation or the like, which is not limited herein. To be specific, after confirming to track the target object identified by the aircraft, the user sends the control instruction to the aircraft by using the control terminal. The control instruction is used for controlling the aircraft to track the target object identified by the aircraft.

Step 618: The aircraft receives the control instruction and determines, based on the control instruction, to track the target object.

In this embodiment of the present invention, the aircraft may identify the target object by using the panoramic image to identify the target object in a form of an omnidirectional angle of view, so that the aircraft can identify the target object in time. The control terminal can display the panoramic image and highlight the target object to prompt the user to identify the target object. Further, tracking is performed on the target object based on the confirmation operation of the user. Therefore, intelligent tracking can be performed on the target object.

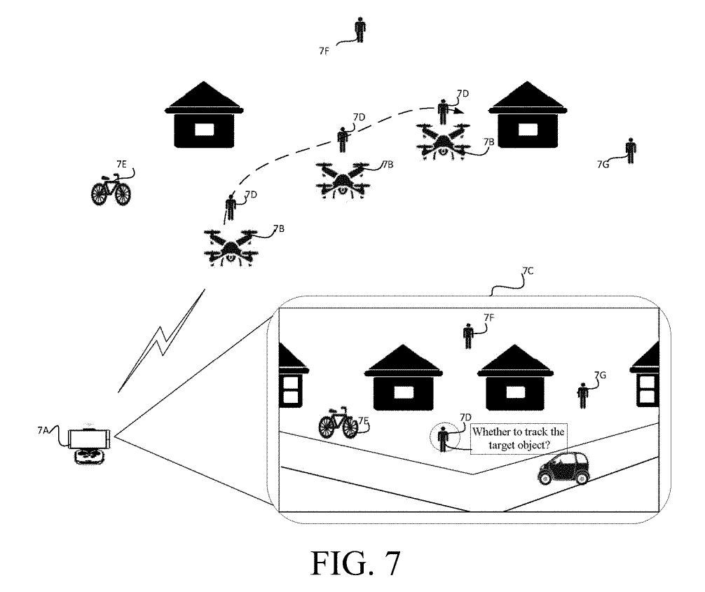

The foregoing embodiment is described below with reference to FIG. 7. As shown in FIG. 7, an aircraft 7B may trigger identification on the target object based on a control instruction of a control terminal 7A. Alternatively, when satisfying a triggering condition, the aircraft 7B triggers identification on a target object. The triggering condition is not limited herein. It is assumed that a pre-stored background model in the aircraft includes an object 7E to an object 7G. When an object 7D appears in a panoramic image, because the object 7D does not exist in the background model, it may be determined that the object 7D is the target object. In addition, area information of the target object 7D and the panoramic image may be sent to the control terminal 7A. The control terminal 7A may control a display screen 7C to display the panoramic image and highlight the target object 7D based on the area information of the target object. Further, the control terminal may further prompt the user to confirm whether to track the target object. For example, as shown in the figure, the user is prompted by using a dialog box. This manner is merely an example. A prompt manner is not limited in this embodiment of the present invention. After receiving a confirmation operation of the user, the control terminal 7A may send a control instruction to the aircraft 7B, so that the aircraft 7B may track the target object 7D based on the control instruction.

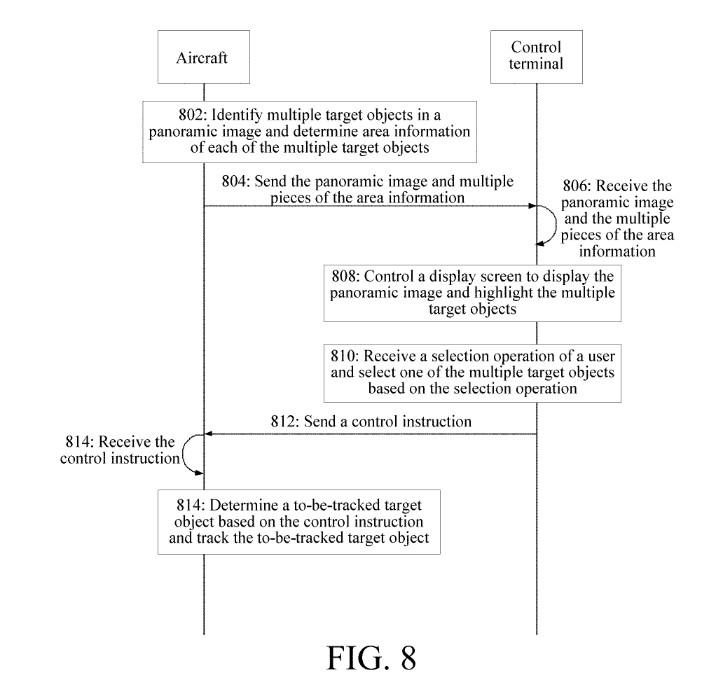

Referring to FIG. 8, FIG. 8 is a schematic flowchart of still another target tracking method according to an embodiment of the present invention. As shown in FIG. 8, the method includes at least the following steps.

Step 802: An aircraft identifies multiple target objects in a panoramic image and determines area information of each of the multiple target objects.

Step 804: The aircraft sends the panoramic image and multiple pieces of the area information to a control terminal.

Step 806: The control terminal receives the panoramic image and the multiple pieces of the area information and confirms the multiple target objects based on the multiple pieces of the area information.

Step 808: The control terminal controls a display screen to display the panoramic image and highlights the multiple target objects.

Step 810: The control terminal receives a selection operation of a user and selects one of the multiple target objects based on the selection operation.

Step 812: The control terminal sends a control instruction to the aircraft, the control instruction being used for controlling the aircraft to track the selected target object.

Step 814: After receiving the control instruction, the aircraft determines a to-be-tracked target object based on the control instruction and tracks the to-be-tracked target object.

For an implementation of obtaining the panoramic image and performing target object identification on the panoramic image by the aircraft, refer to the foregoing embodiment and this is not described herein again.

For example, the aircraft may identify the multiple target objects in the panoramic image and determine the area information of the multiple target objects. The aircraft may send the panoramic image and the area information of the target object to the control terminal. The control terminal determines the multiple target objects based on the area information and controls the display screen to display the panoramic image and highlights the multiple target objects in the panoramic image. The control terminal may prompt the user to select one of the multiple target objects as a to-be-tracked target object. Herein, an implementation of the selection operation of the user is not limited. When the selection operation of the user is detected, a target object corresponding to the selection operation is determined as the to-be-tracked target object. Area information of the target object or indication information that can be used for indicating the target object is sent to the aircraft, so that the aircraft can determine the to-be-tracked target object based on the information sent by the control terminal and track the to-be-tracked target object.

In this embodiment of the present invention, the aircraft may identify the multiple target objects in the panoramic image, thereby improving identification efficiency of the target object. In addition, the aircraft may track one of the target objects based on the selection operation of the user. This can improve intelligence of tracking the target object.

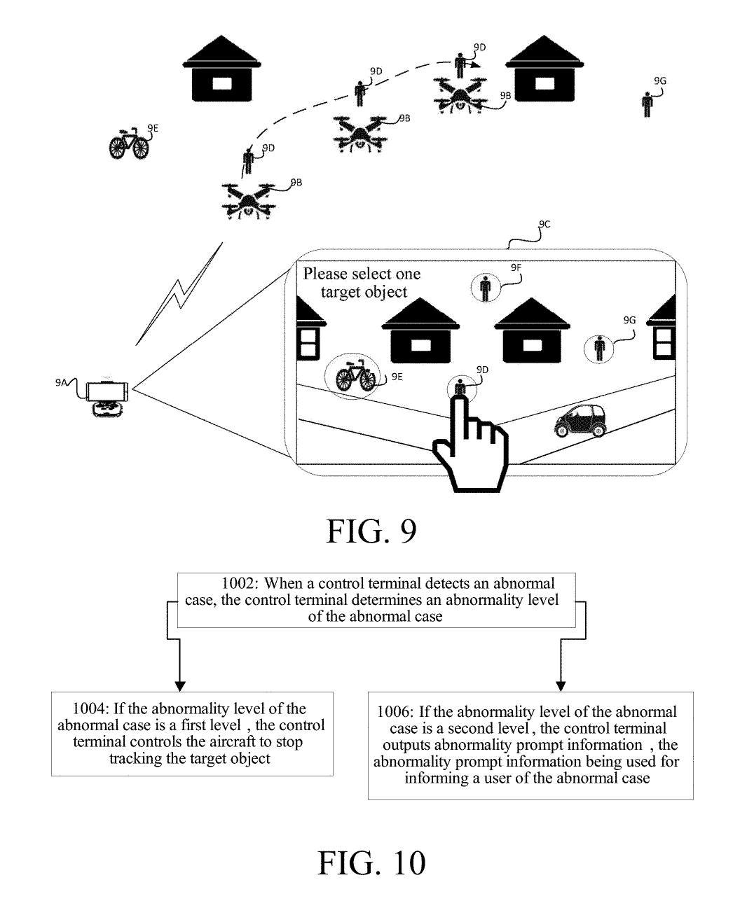

The foregoing embodiment is described below with reference to FIG. 9. As shown in FIG. 9, after an aircraft 9B identifies target objects 9D, 9E, 9F and 9G in a panoramic image, the aircraft 9B may send the panoramic image and information about the multiple target objects to a control terminal 9A. The control terminal 9A may control a display screen 9C to display the panoramic image and highlight the multiple target objects. Further, the control terminal 9A may further prompt the user to select one of the multiple prominently-displayed target objects for tracking. After receiving the selection operation of the user, for example, the user selects the target object 9D as the to-be-tracked target object by using a touch operation, the control terminal 9A may send information about the target object 9D such as area information or feature information to the aircraft. In this way, the aircraft 9B determines, based on the information sent by the control terminal 9A, that the target object 9D is the to-be-tracked target object and tracks the target object 9D.

With reference to any of the foregoing embodiments, after the aircraft tracks the target object, steps described in the following embodiments may be further performed.

Referring to FIG. 10, FIG. 10 is a schematic flowchart of an abnormal case processing method according to an embodiment of the present invention. Referring to FIG. 10, the method includes at least the following steps.

Step 1002: When a control terminal detects an abnormal case, the control terminal determines an abnormality level of the abnormal case.

Step 1004: If the abnormality level of the abnormal case is a first level, the control terminal controls the aircraft to stop tracking the target object.

Step 1006: If the abnormality level of the abnormal case is a second level, the control terminal outputs abnormality prompt information, the abnormality prompt information being used for informing a user of the abnormal case.

For example, the control terminal may determine whether the abnormal case occurs by using a status parameter of the aircraft collected by the control terminal or information fed back by the aircraft. In addition, different execution manners are determined based on a level corresponding to the abnormal case.

An implementation is as follows: When the abnormality level of the abnormal case is the first level, it indicates that the abnormal case is serious, so that the aircraft is controlled to stop tracking the target object. For example, the aircraft is controlled to switch a tracking mode to a self mode or the aircraft is controlled to be in a hover state or the like. This is not limited herein. When the abnormality level of the abnormal case is the second level, it indicates that the user needs to be notified of the abnormal case. The control terminal may output the abnormality prompt information to inform the user of the abnormal case. Further, the aircraft may be controlled based on a user operation. For example, the aircraft is controlled to stop tracking the target object, to return or to change a tracking object. This is not limited herein.

For example, the abnormal case includes, but not limited to, the following cases.

For example, the abnormal case may be that the control terminal receives information, fed back by the aircraft, indicating that a tracked target object is lost. In this abnormal case, the control terminal can determine that the abnormal case is in the second level and may output abnormality prompt information indicating that the target is lost. Further, the user may determine, in a currently-displayed panoramic image, whether there is a target object on which tracking is lost. If yes, the control terminal may determine, based on the user operation, the target object on which tracking is lost and feed back information corresponding to the target object to the aircraft. The aircraft may re-confirm the target object based on the information and track the target object.

For another example, the abnormal case may be that the control terminal does not receive, in a preset time range, an image transmitted by the aircraft or fails to receive an image. In this abnormal case, the control terminal can determine that the abnormality level of the abnormal case is the second level. The control terminal may output abnormality prompt information indicating that transmission of the image fails. Further, the control terminal may receive the user operation and control the aircraft to change a flight route or control the aircraft to stop tracking the target object. This is not limited herein.

For another example, the abnormal case may be that the control terminal detects that an electrical quantity of the aircraft is lower than a preset threshold. In this abnormal case, the control terminal can determine that the abnormality level of the abnormal case is the first level. The control terminal may control the aircraft to stop tracking the target object. Further, the control terminal may control the aircraft to perform a return flight.

For another example, the abnormal case may be that the control terminal cannot come into communication connection to the aircraft. That is, the control terminal fails to send a signal to the aircraft, cannot receive a signal sent by the aircraft or the like. In this case, the control terminal can determine that the abnormality level of the abnormal case is the second level. The control terminal outputs the abnormality prompt information to the user.

For another example, the abnormal case may be that light intensity of an environment in which the aircraft is located is detected to be lower than a preset threshold. In this abnormal case, the control terminal can determine that the abnormality level of the abnormal case is the first level. The control terminal controls the aircraft to stop tracking the target object.

For another example, the abnormal case may be that an obstacle affecting flight is detected to occur surrounding the aircraft. In this abnormal case, the control terminal can determine that the abnormality level of the abnormal case is the second level. The control terminal outputs the abnormality prompt information to the user. The control terminal may further control, based on the user operation, the aircraft to change a flight route or the like. This is not limited herein.

Certainly, the abnormal case may further include another case and may further be divided into multiple other levels. The control terminal may process abnormal cases in each level in a same or different manner. This is not limited herein.

By using the foregoing manner, the control terminal can detect, in time, the abnormal case of the aircraft when the aircraft tracks the target and can process the abnormal case in time.

An apparatus embodiment for implementing one or more steps in any of the foregoing method embodiments is described below.

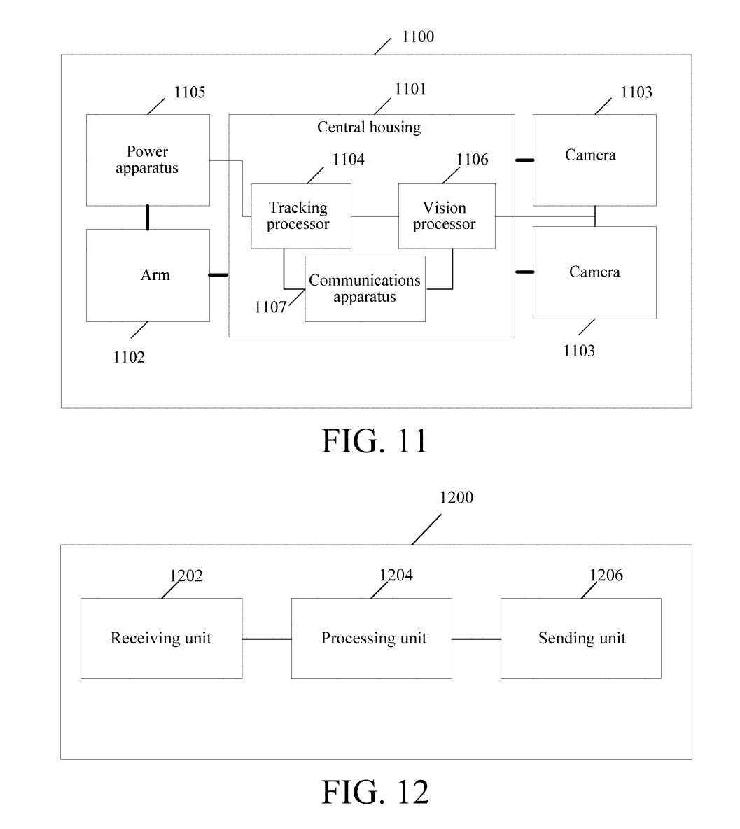

Referring to FIG. 11, FIG. 11 is a schematic structural diagram of an aircraft according to an embodiment of the present invention. The aircraft 1100 may include a central housing 1101, an arm 1102, at least two cameras 1103, a tracking processor 1104, a power apparatus 1105 and a vision processor 1106.

The central housing 1101 and the arm 1102 may be integral or may be physically connected. This is not limited herein. Multiple systems such as a vision system and a flight control system may be disposed in the central housing 1101 or the arm 1102. The foregoing system may be implemented in a combination of hardware and software. For example, the vision processor 1106 may be disposed in the vision system. The tracking processor 1104 may be disposed in the flight control system. In FIG. 11, an example in which the tracking processor 1104 and the vision processor 1106 is disposed in the central housing 1101 is used for description.

The power apparatus 1105 is disposed on the arm 1102. The power apparatus 1105 may be controlled by the flight control system or the tracking processor 1104, so as to implement flight based on an instruction of the flight control system or the tracking processor 1104.

The at least two cameras 1103 may be disposed on the central housing 1101 and/or the arm 1102. In addition, photography directions of the at least two cameras are different. In FIG. 11, two cameras are exemplarily shown and description is provided by using an example in which the two cameras are disposed on the central housing 1101. The at least two cameras 1103 may be connected to the vision system or the vision processor 1106, so that the at least two cameras 1103 can perform photographing based on an instruction of the vision system or the vision processor 1106 or send a captured image or video to the vision system or a control terminal based on the instruction of the vision system or the vision processor 1106.

Certainly, the aircraft may further include other components such as a chargeable battery, an image transmission system, a gimbal interface and various sensors configured to collect information (for example, an infrared sensor, an environment sensor and an obstacle sensor). This is not limited herein.

The tracking processor 1104 or the vision processor 1106 may be an integrated circuit chip having a signal processing capability. Alternatively, the tracking processor 1104 or the vision processor 1106 may be a general-purpose processor, a digital signal processor, an invention-specific integrated circuit, a field programmable gate array or another programmable logic component, a discrete gate or a transistor logic device, or a discrete hardware component.

The aircraft may further include one or more memories. The memory may be connected to the tracking processor 1104 and the vision processor 1106. The tracking processor 1104 or the vision processor 1106 may invoke a computer program stored in the memory to implement a method for identifying an image or the like. The memory may include a read-only memory, a random access memory, a non-volatile random access memory or the like, which is not limited herein.

With reference to the foregoing structure, the following exemplarily describes functions of the components on implementing the foregoing method.

For example, the vision processor 1106 is configured to: obtain an image captured by each of the at least two cameras at a same time point, and stitch the images captured by the cameras to obtain a panoramic image.

The vision processor 1106 is further configured to identify a target object in the panoramic image and to send an instruction for tracking the target object to the tracking processor.

The tracking processor 1104 controls, based on the instruction, a rotation speed of the power apparatus 1105 to track the target object.

Optionally, the aircraft may further include a communications apparatus 1107. The communications apparatus 1107 may be disposed in the central housing 1101 or the arm 1102. FIG. 11 exemplarily shows that the communications apparatus 1107 is disposed in the central housing 1101. The communications apparatus may include components such as a transceiver and an antenna, configured to perform communication connection to an external device, for example, to the control terminal.

For example, the communications apparatus 1107 may be configured to receive an instruction or information of the control terminal and send the instruction or information to the tracking processor 1104, so that the tracking processor 1104 determines whether to track the target object. Alternatively, the communications apparatus 1107 may be configured to receive an instruction sent by the vision processor 1106 and send the panoramic image or related information of the target object to the control terminal, so as to implement interaction between the aircraft and the control terminal. This is not limited herein.

As shown in FIG. 12, FIG. 12 is a schematic structural diagram of units of an aircraft. The aircraft 12 may include a receiving unit 1202, a processing unit 1204 and a sending unit 1206.

The receiving unit 1202 is configured to obtain an image captured by each of at least two cameras at a same time point, where photography directions of the multiple cameras are different.

The processing unit 1204 is configured to stitch multiple images to obtain a panoramic image.

The sending unit 1206 is configured to send the panoramic image to a control terminal.

The processing unit 1204 is further configured to identify a target object in the panoramic image and control the aircraft to track the target object.

Certainly, the foregoing functional units are further configured to perform any of the methods performed by the aircraft in the foregoing embodiments. This is not described herein again.

Functions of the foregoing functional units may be implemented by combining related components described in FIG. 11 with a related program instruction stored in the storage unit. This is not limited herein.

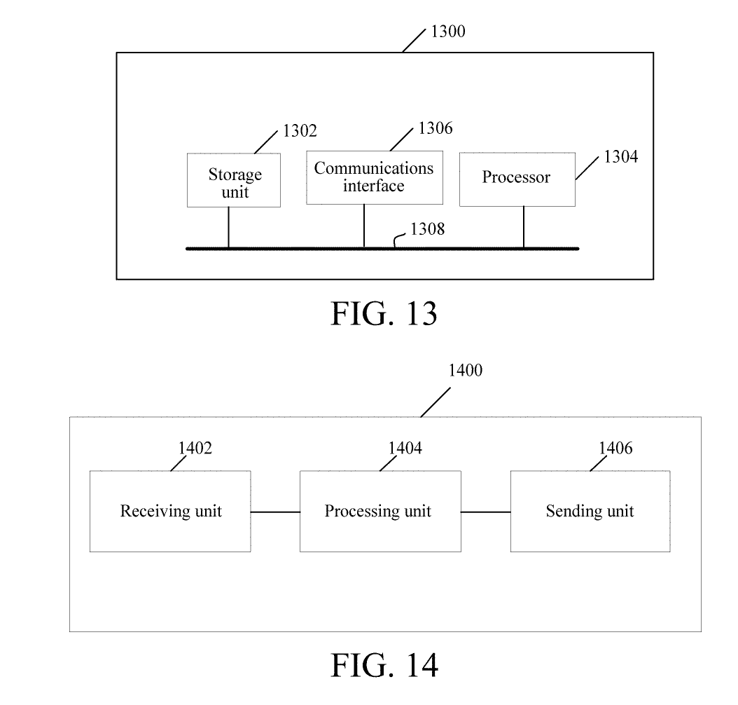

Referring to FIG. 13, FIG. 13 is a schematic structural diagram of a control terminal according to an embodiment of the present invention. The control terminal 1300 may include a storage unit 1302, a processor 1304 and a communications interface 1306. The processor 1304 is coupled to the storage unit 1302 and the communications interface 1306. The storage unit 1302 is configured to store program code and data. The processor 1304 is configured to invoke the program code and data to perform any of the methods performed by the control terminal. The communications interface 1306 is configured to communicate with an aircraft or a user terminal under control of the processor 1304.

The processor 1304 may further include a central processing unit (CPU). Alternatively, the processor 1304 may alternatively be understood as a controller. The storage unit 1302 may include a read-only memory and a random access memory, and provide instructions and data to the processor 1304. A part of the storage unit 1302 may further include a non-volatile random access memory. Specifically, components during invention are coupled together by using, for example, a bus system. The bus system may further include a power bus, a control bus, a status signal bus or the like in addition to a data bus. However, for ease of clear description, all types of buses in the figure are marked as a bus system 1308. The foregoing method disclosed by this embodiment of the present invention may be implemented by the processor 1304. The processor 1304 may be an integrated circuit chip and has a signal processing capability. In an implementation process, steps in the foregoing methods may be completed by using an integrated logical circuit of hardware in the processor 1304 or instructions in a faun of software in the processor 1304. The processor 1304 may be a general-purpose processor, a digital signal processor, an invention-specific integrated circuit, a field programmable gate array or another programmable logic component, a discrete gate or a transistor logic device, or a discrete hardware component. The processor 1304 may implement or execute methods, steps and logical block diagrams disclosed in the embodiments of the present invention. The processor 1304 may be an image processor, a microprocessor, any conventional processor or the like. The steps in the methods disclosed with reference to the embodiments of the present invention may be directly performed by a hardware decoding processor, or may be performed by combining hardware and software modules in a decoding processor. The software module may be located in a mature storage medium in the art, such as a random access memory, a flash memory, a read-only memory, a programmable read-only memory, an electrically-erasable programmable memory or a register. The storage medium is located in the storage unit 1302. For example, the processor 1304 can read the program code and data in the storage unit 1302 to complete, in combination with hardware of the processor 1304, the steps in the foregoing method performed by the control terminal.

With reference to the foregoing structure, the control terminal may further implement any of the foregoing methods by using a functional unit. The functional unit may be implemented by hardware, software or a combination of hardware and software. This is not limited herein.

As shown in FIG. 14, FIG. 14 is a schematic block diagram of units of a control terminal. The control terminal 1400 may include a receiving unit 1402, a processing unit 1404 and a sending unit 1406.

The receiving unit 1402 is configured to receive a panoramic image sent by an aircraft.

The panoramic image is obtained by stitching, by the aircraft, multiple images captured by multiple cameras connected to the aircraft at a same time point. Photography directions of the multiple cameras are different.

The control unit 1404 is configured to control a display screen to display the panoramic image.

The sending unit 1406 is configured to send instructions or information to the aircraft or another device, which is not limited herein.

Certainly, the foregoing functional units are further configured to perform any of the methods performed by the control terminal in the foregoing embodiments. This is not described herein again.

Functions of the foregoing functional units may be implemented by combining related components described in FIG. 13 with a related program instruction stored in the memory. This is not limited herein.

Although the present invention is shown and described with reference to exemplary embodiments of the present invention, a person skilled in the art should understand that multiple changes can be made to the forms and details of the present invention without departing from the spirit and scope of the present invention limited by the appended claims and an equivalent of the claims. Therefore, the scope of the present invention should not be limited to the foregoing embodiments. The scope of the present invention is not only determined by the appended claims, but is also limited by the equivalent of the appended claims.

What is claimed is:

1. A target tracking method, comprising:
obtaining images captured by each of at least two cameras at the same time, wherein photography directions of the at least two cameras are different;
stitching the images captured by the cameras to obtain a panoramic image; and
if a target object is identified in the panoramic image, tracking the target object.

2. The method according to claim 1, further comprising:
sending the panoramic image to a control terminal, so that the panoramic image is displayed by the control terminal;
receiving indication information sent by the control terminal, the indication information being used for instructing a first object selected from the panoramic image by a user; and
determining whether the first object exists in the panoramic image; and if yes, determining that the target object is identified in the panoramic image, and using the first object as the target object.

3. The method according to claim 2, wherein the determining whether the first object exists in the panoramic image comprises:
obtaining a set of panoramic image sequences, wherein the panoramic image sequence comprises multiple panoramic images;
sequentially detecting whether the first object is comprised in each panoramic image in the panoramic image sequence, and determining a proportion of a panoramic image comprising the first object in the panoramic image sequence;
determining whether the proportion is greater than or equal to a first preset threshold; and
if yes, determining that the first object exists in the panoramic image; or if not, determining that the first object does not exist in the panoramic image.

4. The method according to claim 1, further comprising:
comparing the panoramic image with an established background model;
identifying that a second object of the panoramic image does not exist in background model; and
determining the second object as the target object.

5. The method according to claim 4, further comprising:
determining area information of the target object in the panoramic image; and
sending the panoramic image and the area information of the target object to a control terminal, wherein the control terminal is configured to display the target object based on the area information.

6. The method according to claim 1, wherein before the tracking the target object, the method further comprises:
receiving a first control instruction that is used for indicating tracking and that is sent by the control terminal.

7. The method according to claim 1, wherein after the tracking the target object, the method further comprises:
receiving a second control instruction that is used for indicating abnormality and that is sent by the control terminal; and
stopping tracking the target object.

8. An aircraft, comprising:
a central housing;
an arm;
at least two cameras, wherein the at least two cameras are located on the central housing or the arm and photography directions of the at least two cameras are different;
a tracking processor, disposed in the central housing or the arm;
a power apparatus, disposed on the arm; and
a vision processor, disposed in the central housing or the arm, wherein
the vision processor is configured to: obtain images captured by each of the at least two cameras at the same time, and stitch the images captured by the cameras to obtain a panoramic image;
the vision processor is further configured to identify a target object in the panoramic image and to send an instruction for tracking the target object to the tracking processor; and
the tracking processor controls, based on the instruction, a rotation speed of the power apparatus to track the target object.

9. The aircraft according to claim 8, further comprising a communications apparatus, wherein the communications apparatus is disposed in the central housing or the arm;
the communications apparatus is configure to send the panoramic image to a control terminal, so that the panoramic image is displayed by the control terminal;
the communications apparatus is further configure to receive indication information sent by the control terminal, the indication information being used for instructing a first object selected from the panoramic image by a user;
the communications apparatus is further configure to send the received indication information to the vision processor; and
the vision processor is configure to: determine whether the first object exists in the panoramic image; and if yes, determine that the target object is identified in the panoramic image, and use the first object as the target object.

10. The aircraft according to claim 9, wherein the vision processor is specifically configure to:
obtain a set of panoramic image sequences, wherein the panoramic image sequence comprises multiple panoramic images;
sequentially detect whether the first object is comprised in each panoramic image in the panoramic image sequence, and determine a proportion of a panoramic image comprising the first object in the panoramic image sequence;
determine whether the proportion is greater than or equal to a first preset threshold; and
if yes, determine that the first object exists in the panoramic image; or if not, determine that the first object does not exist in the panoramic image.

11. The aircraft according to claim 8, wherein the vision processor is further configured to:
compare the panoramic image with an established background model;
identify that a second object of the panoramic image does not exist in the background model; and
determine the second object as the target object.

12. The aircraft according to claim 11, wherein
the vision processor is further configured to determine area information of the target object in the panoramic image and to send the area information of the target object to a communications apparatus; and
the communications apparatus is further configured to send the panoramic image and the area information of the target object to a control terminal, wherein the control terminal is configured to display the target object based on the area information.

13. The aircraft according to claim 12, wherein
the communications apparatus is further configured to receive a first control instruction that is used for indicating tracking and that is sent by the control terminal; and
the communications apparatus is further configured to transmit the first control instruction to the tracking processor.

14. The aircraft according to claim 10, wherein,
the communications apparatus is further configured to receive a second control instruction that is used for indicating abnormality and that is sent by the control terminal;
the communications apparatus is further configured to send the second control instruction to the tracking processor; and
the tracking processor is further configured to stop tracking the target object.
